(19) United States
(12) Patent Application Publication
(10) Pub. No.: US 2020/0180695 A1
(43) Pub. Date: Jun. 11, 2020

(54) PARKING ROBOT FOR A TRANSPORTATION VEHICLE AND METHOD FOR OPERATING SUCH A PARKING ROBOT

(71) Applicant: VOLKSWAGEN AKTIENGESELLSCHAFT, Wolfsburg (DE)

(72) Inventors: Theodoros TZIVANOPOULOS, Wolfsburg (DE); Julius IBENTHAL, Lehrte (DE)

(73) Assignee: Volkswagen Aktiengesellschaft

(21) Appl. No.: 16/702,913

(22) Filed: Dec. 4, 2019

(30) Foreign Application Priority Data
Dec. 6, 2018 (DE) 10 2018 221 174.4

(51) Int. Cl. B62D 15/02; E04H 6/42; B60S 13/00; E04H 6/34; E04H 6/36; E04H 6/30; B60W 10/20; B60W 30/06

(52) U.S. Cl. CPC B62D 15/0285; E04H 6/424; B60S 13/00; E04H 6/34; B60W 30/06; E04H 6/305; B62D 15/021; B60W 10/20; E04H 6/36

(57) ABSTRACT

A parking robot for a transportation vehicle and a method for operating a parking robot. The parking robot has a pair of wheel bearing arms which use a crank element to indirectly mount rotatably about a respective rotation axis. The parking robot autonomously moves from the outside to a receiving position beside a wheel of a wheel axle of the transportation vehicle in which the respective wheel bearing arms are parallel with the wheel axle and one of the wheel bearing arms in a vehicle longitudinal direction is positioned in front of the wheel and the other wheel bearing arm in the vehicle longitudinal direction is positioned behind the wheel. The parking robot raises the wheel of the transportation vehicle by rotating the respective wheel bearing arm about the respective rotation axis in a predefined rotation direction, wherein the respective rotation directions of the respective wheel bearing arms are mutually opposed.

### PRIORITY CLAIM

This patent application claims priority to German Patent Application No. 10 2018 221 174.4, filed 6 Dec. 2018, the disclosure of which is incorporated herein by reference in its entirety.

### SUMMARY

Illustrative embodiments relate to a parking robot for a transportation vehicle and to a method for operating a parking robot of this type for a transportation vehicle.

### BRIEF DESCRIPTION OF THE DRAWINGS

An exemplary embodiment is described hereunder. To this end, in the figures:

FIG. 1 shows a sectional illustration of a parking robot which raises a wheel of a transportation vehicle;

FIG. 2 shows a longitudinal section of the parking robot which raises a wheel of a transportation vehicle; and

FIG. 3 shows a plan view of a lock disk having a safety key.

### DETAILED DESCRIPTION

A parking robot is usually conceived for transporting a transportation vehicle within a predefined infrastructural environment, for example, a covered car park, to a predefined parking position. To this end, the parking robot, for example, by way of at least a sub-region, moves below the transportation vehicle, raises the latter, and thereafter, conjointly with the raised transportation vehicle, moves to the predefined parking position where the parking robot sets down the transportation vehicle again. Transportation vehicles, independently of whether or not the transportation vehicles have, for example, a driver assistance system for at least partially autonomous parking, by a parking robot can thus be moved in a fully autonomous manner and thus without any input of a driver of the transportation vehicle within the infrastructural environment.

An omnidirectional mobile motor vehicle transport platform which has at least three Mecanum wheels is described in DE 10 2016 224 098 A1. By way of this mobile motor vehicle transport platform, it is possible to move into the intermediate space between a vehicle floor pan of a motor vehicle and a carriageway, and for the motor vehicle thereafter to be raised from the carriageway by a lifting device of the motor vehicle transport platform. The motor vehicle is hereby raised from the carriageway at least axle-by-axle or completely.

A transport carriage for a motor vehicle which on two opposite sides has respective clamping parts and is conceived for being positioned below the motor vehicle and by way of the respective clamping parts for raising a respective wheel of a wheel axle of the motor vehicle is described in CN 207761382 U.

Disclosed embodiments provide a solution by way of which a parking robot can raise a wheel of a transportation vehicle from the driving floor.

The disclosure is based on the concept that temporary forces of different sizes are required for raising the wheel while raising a wheel of a transportation vehicle by wheel bearing arms of a parking robot. For example, it may be the case that a small force to be applied by the parking robot can be sufficient when commencing the raising action, but comparatively high forces are required for further raising the wheel in a progressed stage of the raising action, wherein the force required for raising the wheel continuously increases during a raising procedure, for example. It is, therefore, expedient for a force for raising the wheel of a transportation vehicle that is provided by a lever, that is to say by a wheel bearing arm of the parking robot, for example, to be designed so as to be variable during the raising procedure.

Accordingly, a parking robot for a transportation vehicle which has a pair of wheel bearing arms is provided. The two wheel bearing arms are in each case disposed on a parking robot main body of the parking robot so as to be perpendicular to a parking robot longitudinal direction. The pair of wheel bearing arms in a parking robot transverse direction thus protrudes from the parking robot, that is to say that the wheel bearing arms protrude laterally from the parking robot main body. The wheel bearing arms can also be designed so as to be foldable, this being described further below. The arrangement described here in this instance represents the outward-folded position. The respective wheel bearing arms of the parking robot by a crank element are in each case at least indirectly mounted on the parking robot so as to be rotatable about a respective rotation axis. In other words, the respective wheel bearing arm by the crank element thereof can thus be pivoted up and down. A crank element generally refers to a bar-shaped or plate-shaped machine element which is rotatable at one end and which by an engagement of force at the free end thereof can be set in rotation. In the case of the parking robot, one of the wheel bearing arms of the parking robot is situated at one end of the respective crank element, wherein the other end of the crank element is at least indirectly mounted on the rotatable machine element which rotates about the rotation axis. The machine element can be formed, for example, by a shaft element to which the crank element is rigidly connected. In a rotating movement about the rotation axis which presently is thus to be understood as a straight line about which the shaft element rotates conjointly with the crank element and the wheel bearing arm, the respective wheel bearing arm is thus rotated about a rotation center of the machine element and thus about the rotation axis, wherein a radius of the rotating movement corresponds to a longitudinal extent of the crank element. It is ultimately enabled on account thereof that the respective wheel bearing arm is conceived for carrying out a circular movement about the rotation center of the rotation axis as soon as a rotating movement about the rotation axis is performed.

The parking robot is now conceived for autonomously moving from the outside to a receiving position beside a wheel of a wheel axle of the transportation vehicle. In the receiving position the respective wheel bearing arms are in each case disposed so as to be parallel with the wheel axle of the transportation vehicle, and one of the wheel bearing arms in the transportation vehicle longitudinal direction is positioned in front of the wheel and the other wheel bearing arm in the transportation vehicle longitudinal direction is positioned behind the wheel. The parking robot is thus conceived for moving close to the transportation vehicle in a self-driving manner and for positioning itself in the region of one of the wheels of the transportation vehicle in such a manner that the parking robot by way of the respective wheel bearing arms thereof comprises the respective wheel on both sides, thus from the front and the rear in the transportation vehicle longitudinal direction. The respective wheel bearing arms herein can in each case already contact a wheel envelope of the wheel of the transportation vehicle at respective opposite external sides.

However, it is also possible for the respective wheel bearing arms in the receiving position to be disposed at a respective spacing from the wheel, the spacing depending on a wheel diameter of the wheel. The pair of wheel bearing arms may be disposed rigidly on the parking robot, typically at an angle of 90 degrees in relation to a surface of the parking robot, such that the spacing between the wheel bearing arms is initially not dynamically adapted to the wheel diameter of the wheel. Alternatively or additionally thereto, it is possible for the respective wheel bearing arms to be capable of being folded inward and outward and initially, for example, be disposed in an inward-folded position so as to be folded toward the parking robot main body, and be folded outward only once the parking robot has autonomously moved from the outside beside the wheel of the transportation vehicle. There, the wheel bearing arms can assume the receiving position described above, which in this example corresponds to an outward-folded position of the respective wheel bearing arms.

The parking robot is, moreover, conceived for raising the wheel of the transportation vehicle by correspondingly rotating the respective wheel bearing arm about the respective rotation axis in the predefined rotation direction. The respective rotation directions of the respective wheel bearing arms herein are mutually opposed. For example, the wheel bearing arm which in the transportation vehicle longitudinal direction is positioned in front of the wheel can be rotated toward the wheel for the wheel to be raised, wherein the wheel bearing arm positioned behind the wheel to this end is rotated counter thereto, likewise toward the wheel. The entire rotating movement during the raising of the wheel of the transportation vehicle from a driving floor herein may comprise a rotation angle in the range from 70° to 110°, for example, of 90 degrees. For the transportation vehicle to be set down, for example, the respective wheel bearing arms can be rotated in the respective opposite rotation direction to the respective predefined rotation direction described, on account of which the wheel of the transportation vehicle is ultimately moved from the previously raised position back down to the driving floor. The wheel bearing arms thus lifted the wheel on account of the rotating movement of the wheel bearing arms.

A lever mechanism by way of which a wheel of a transportation vehicle can be raised is thus provided. Since a total of four parking robots are required for raising the transportation vehicle having four wheels, for example, so as to raise and transport the transportation vehicle, for example, within a covered car park, to a predefined parking bay, for example, the mass of the transportation vehicle to be supported by the parking robot can thus be distributed to four parking robots. The parking robots possess in each case the described components for raising or setting down, respectively, the wheel of the transportation vehicle. Since each wheel is individually transported by one parking robot, ramps and inclines within a covered car park, for example, can thus be reliably negotiated, since no parking robot components having a small ground clearance, for example, are disposed over a majority of an area of a transportation vehicle floor pan, the parking robot components potentially bottoming out on ramps or inclines of the type, on account of which transporting the transportation vehicle from one covered car park level to another covered car park level is made simple, for example. By way of parking robots configured according to the disclosure, a transportation vehicle can thus be raised from the driving floor and be transported across sloped floors.

Design embodiments on account of which additional benefits are derived are also part of the disclosure.

In at least one disclosed design embodiment, it is provided that the respective wheel bearing arm by way of a respective eccentric cable drum is at least indirectly coupled rigidly to the respective crank element. The eccentric cable drum herein has a first sub-region having a predefined first drum radius and a second sub-region having a predefined second drum radius, wherein the second drum radius is larger than the first drum radius. The cable drum can thus have an elliptic drum face, for example, which is disposed so as to be perpendicular to a cable drum rotation axis, the cable drum being mounted so as to be rotatable about the cable drum rotation axis. While rotating the respective wheel bearing arm about the respective rotation axis in the predefined rotation direction, the cable drum is rotated, for example, by one quarter of the elliptic basic shape thereof, when the entire rotating movement while raising the wheel of the transportation vehicle from the driving floor has the rotation angle of 90 degrees as mentioned above in an exemplary manner. Same applies in analogous manner for other rotation angles from the angular range mentioned. The coupling between the respective wheel bearing arm to the respective eccentric cable drum by way of the respective crank element herein is immovable.

One cable is in each case wound around the respective eccentric cable drum, and the respective cable drum is mounted so as to be rotatable about the respective rotation axis, the respective wheel bearing arm conjointly with the respective crank element being also mounted so as to be rotatable about the respective rotation axis. The parking robot moreover has a central drive unit which is conceived for unwinding or winding the respective cable on the respective cable drum. Two separate cables may be provided herein, one cable being in each case for the cable drum of one of the wheel bearing arms, the separate cables being wound or unwound, respectively, on separate respective drums on the central drive unit. For example, when the central drive unit rotates in a predefined rotation direction of the drive unit, cable is wound on this central drive unit, for example, and herein is unwound from the respective eccentric cable drum. By way of the unwinding of the respective cable from the respective cable drum to a drum of the central drive unit, respectively, the respective cable drum can be rotated in such a manner, for example, that a respective length of the cable between the cable drum and the drum of the electric drive unit is varied. When the winding of the cable on the drum of the central drive unit commences, for example, when the eccentric cable drum is just being positioned relative to the central drive unit in such a manner that the eccentric cable drum by way of the first sub-region having the small first drum radius points in the direction of the central drive unit, the respective eccentric cable drum by further winding the cable onto the drum of the central drive unit on account of the rotating movement of the drive unit is moved in such a manner that the eccentric cable drum is ultimately positioned relative to the central drive unit in such a manner that the eccentric cable drum by way of the second sub-region having the second drum radius which is larger than the first drum radius is oriented in the direction of the central drive unit. On account thereof, the respective cable length between the eccentric cable drum and the drum of the external drive unit is reduced, for example, on account of the rotation of the drive unit.

Depending on the length of the cable between the eccentric cable drum and the central drive unit, the greater the force which can be exerted by the wheel bearing arm on the wheel of the transportation vehicle. In the rotation of the wheel bearing arm by 90 degrees about the rotation axis it is thus expedient that the eccentric cable drum, for example, is initially disposed in such a manner that the eccentric cable drum by way of the second sub-region having the second, larger, drum radius is oriented in the direction of the central drive unit such that the cable length is ideally short. Thereafter, the cable is wound on the drum of the central drive unit, for example, on account of the rotating movement about the rotation axis of the central drive unit, on account of which the eccentric cable drum is imparted a rotating movement on account of which the shaft element, and consequently also the crank element conjointly with the wheel bearing arm, rotates about the rotation axis. In the rotation, the cable between the cable drum and the drum of the central drive unit increases in size until the eccentric cable drum after the rotation by 90 degrees is disposed in such a manner that the eccentric cable drum by way of the first sub-region having the first, short, drum radius is oriented in the direction of the central drive unit. The force by way of which the wheel bearing arm herein acts on the wheel of the transportation vehicle steadily increases during the rotation movement and the rotating movement caused on account thereof. On account thereof, when raising the wheel more force for raising is provided precisely when the additional force is required, specifically this typically arises as from the rotation of the wheel bearing arm by typically 45 degrees after the commencement of the raising procedure.

Alternatively to a respective eccentric cable drum, a respective eccentric can be coupled to the respective wheel bearing arm by way of the respective crank element. Alternatively thereto, a respective camshaft as a shaft element would also be conceivable, the respective wheel bearing arm being at least indirectly coupled rigidly to the respective crank element on the camshaft.

It is ultimately achieved on account of the eccentric cable drum that a variable moment, that is to say a variable force, on the wheel bearing arm is achieved by way of a constant rotating speed and a consistent force on the cable, this being beneficial for raising the wheel and simplifying the raising of the wheel. With the aid of the eccentric cable drum, that is to say with the aid of an eccentric shaft, it is specifically possible for a force provided for raising the wheel to increase across a rotation angle. On account thereof, it ultimately becomes possible for the wheel of the transportation vehicle to be raised by way of a relatively minor cable force. Only a relatively small installation space is thus required in the parking robot, since a central drive unit of small dimensions is sufficient to be able to raise even heavy transportation vehicles. On account thereof, the parking robot moreover becomes cost-effective in terms of a parking robot production.

In at least one disclosed embodiment, it is provided that a respective lock disk is coupled to the respective crank element and is mounted so as to be rotatable about the respective rotation axis. The lock disk has a plurality of teeth which by way of predefined spacings and predefined dimensions are disposed on an external periphery of the lock disk. The respective lock disk is assigned a respective safety key which possesses a dedicated respective holding mechanism. The respective safety key, by the respective holding mechanism, is now conceived for being brought to bear on the respective lock disk. This is performed always, for example, when a wheel of the transportation vehicle is to be raised with the aid of the parking robot. Moreover, the respective lock disk in the rotation of the respective lock disk is conceived for moving about the respective rotation axis in the predefined rotation direction from one tooth of the lock disk to another tooth that is adjacent in the rotation direction. For example, when the wheel of the transportation vehicle is raised on account of rotating the respective wheel bearing arm about the respective rotation axis in the predefined rotation direction, the safety key is continuously moved onward from one tooth of the lock disk to the next tooth. The lock disk is moreover conceived for blocking a rotation in the opposite rotation direction. This is possible since the individual teeth have in each case a steep side and a side that is comparatively less steep, such that the respective safety key can slide from one tooth to another along the sides of lesser steepness, but the safety key in the opposite direction is blocked in the movement thereof by the steep side, the safety key not being able to slide further across the steep side to the adjacent tooth in the rotation direction. A safety mechanism is thus possible with the aid of the lock disk, such that the respective wheel bearing arms do not rotate in an uncontrolled manner in opposite rotation directions and release the wheel of the transportation vehicle in an uncontrolled manner back to the driving floor in the case of a cable rupture, for example. This is because the safety key locks into one of the teeth of the lock disk and does not permit any rotating movement in the opposite direction.

When a terminal position of the rotation of the respective wheel bearing arm about the rotation axis is reached, it can moreover be ensured by the lock disk that the wheel of the transportation vehicle remains in the raised position and is not moved away from the raised position on account of a further or opposite rotating movement of the wheel bearing arm. The lock disk thus rotates and the safety key in a self-acting manner always jumps onward by one tooth while the wheel is being raised. In the event of a failure, for example, a cable rupture, the safety key is however retained on a flank, that is to say the steep side, of the respective tooth. The raising mechanism of the parking robot is thus reliable and safeguarded in relation to potential complications such as, for example, a cable rupture of one or both cables of the parking robot.

In at least one further disclosed design embodiment, it is provided that the safety key for setting down the wheel of the transportation vehicle during a corresponding rotation of the respective wheel bearing arm about the respective rotation axis in the opposite rotation direction, by the holding element is conceived for being held at a predefined spacing from the lock disk. The safety key is thus released for the lock disk for the wheel of the transportation vehicle to be set down, and the respective wheel arms move downward by way of a dead weight of the transportation vehicle, that is to say that the respective crank element conjointly with the respective wheel bearing arm is rotated downward in the direction of the driving floor. This herein is moreover controlled and checked with the aid of the respective cable and the central drive unit. The safety key thus does not bear on the lock disk during the lowering action. The lowering action of the wheel of the transportation vehicle is possible in an overall particularly reliable and simple manner on account thereof.

The described parking robot is thus overall particularly suitable for implementing a raising mechanism for a wheel of a transportation vehicle by way of a parking robot, since the described parking robot is scaled so as to be particularly small, that is to say space-saving, and so as to be producible in a cost-effective manner.

In at least one further disclosed design embodiment, it is provided that the respective wheel bearing arms have a respective slip roller. The slip roller is a passive roller which is mounted so as to be at all times rotatable about a dedicated rotation axis. The respective slip roller is thus not disposed so as to be fixed in relation to the parking robot as well as to the raised wheel. The respective rotation axis of the respective slip roller is disposed so as to be parallel with the rotation axis and in the receiving position is thus disposed so as to be parallel with a wheel axle of the transportation vehicle. Once the parking robot has been automatically moved from the outside beside one of the wheels of the transportation vehicle, the wheel is raised by rotating the pair of wheel bearing arms, wherein the respective wheel bearing arms herein are disposed so as to be parallel with the wheel axle of the transportation vehicle in the region of the wheel. The respective slip rollers, in a longitudinal direction of the respective slip rollers, in this instance are thus disposed so as to be parallel with the wheel axle of the transportation vehicle and thus so as to be perpendicular to a circular wheel face of the wheel of the transportation vehicle. When the wheel bearing arms are pushed against the respective wheel of the transportation vehicle, the wheel can slip on the slip rollers, wherein the wheel is ultimately raised from the transportation vehicle floor pan when the respective wheel bearing arms have reached the terminal positions thereof. By pushing against the respective wheel by way of respective wheel bearing arms on both sides, it is achieved that the transportation vehicle when raising and optionally when setting down the transportation vehicle does not roll away, and the raising and the setting down are moreover particularly efficient in terms of the energy required for raising and setting down the transportation vehicle, respectively.

In at least one further disclosed design embodiment, it is provided that the parking robot comprises a sensor installation which is conceived for detecting an environment of the parking robot as well as for localizing obstacles to the parking robot in the detected environment. The sensor installation of the parking robot can be, for example, a camera, radar apparatus, laser scanner, an ultrasonic apparatus, or a Lidar apparatus. The sensor installation may be disposed in an upper sub-region of the parking robot. The sensor installation is now conceived for observing and recording the environment of the parking robot, for example, so as to detect columns in a covered car park, other transportation vehicles within the covered car park, or people moving in the covered car park. The sensor installation is moreover conceived for establishing whether a detected object in the environment of the parking robot is an obstacle to the parking robot and for localizing the object in the environment of the parking robot. For example, columns in the covered car park, or the other transportation vehicles which move in the covered car park, can be potential obstacles to the parking robot and to the transportation vehicle raised by the parking robot, for example, when a travel trajectory of the parking robot leads toward the respective obstacle.

A travel trajectory for the parking robot from the start position to the target position in the covered car park can be determined, for example, by a control installation of the parking robot, while considering the environment detected and the obstacles localized in the environment based on the data detected and determined by the sensor installation. The travel trajectory is however only suitable for travel at relatively low speeds of typically at most 5 to 6 km/h. If the parking robot, or the plurality of parking robots, respectively, which has/have raised the respective wheels of the transportation vehicle is/are to be able to travel more rapidly through the covered car park, for example, respective travel trajectories or other actuation signals for the respective parking robot can be provided, for example, by a pilot robot such that travel to the target position in the covered car park is also possible at higher speeds. Moreover cartographic data of the environment, for example, of the covered car park, can be considered when determining the respective travel trajectories of the respective parking robots. The cartographic data can be provided, for example, from the covered car park administration server, that is to say from an infrastructural administration server, the pilot robot, and/or the respective parking robots. However, the parking robot on account of the sensor installation dedicated to the parking robot is at all times capable of swiftly detecting and localizing obstacles in the environment thereof such as, for example, a ball rolling toward the parking robot, and optionally of correspondingly adapting a travel trajectory transmitted to the robot, and/or of initiating an emergency stop. By the parking robot, the transportation vehicle by correspondingly actuating a drive machine of the transportation vehicle according to the travel trajectory that has optionally been adapted based on the sensor installation can thus be moved within the covered car park such that the autonomous travel of the parking robot with the raised wheel of the transportation vehicle to the target position in the covered car park is possible in a particularly reliable manner.

In at least one disclosed embodiment, it is provided that the parking robot comprises an electric drive machine, a battery for supplying the electric drive machine with electric power, and at least one drive wheel. The parking robot by the electric drive machine is more over conceived for driving the at least one drive wheel for the parking robot to be moved. The parking robot, independently of the transportation vehicle or of other parking robots, is thus conceived for actuating the wheel bearing arms thereof and for moving on the driving floor, for example, within an infrastructural environment such as a covered car park. The parking robot by the electric drive machine, the battery, and the at least one drive wheel is moreover conceived for negotiating ramps or other inclines, for example, within the infrastructural environment. The parking robot can moreover comprise a control installation which is conceived for actuating the electric drive machine in such a manner that the electric drive machine autonomously moves the parking robot on the, for example, predefined, travel trajectory from the start position to the target position, for example, to a predefined parking bay in the covered car park. The parking robot, additionally to a dead weight of the parking robot, is moreover conceived for supporting at least a sub-mass of the transportation vehicle, so that a transportation vehicle having four wheels, for example, can be transported by a total of four parking robots which possess in each case an electric drive machine, a battery for supplying the electric drive machine with electric power, as well as at least one drive wheel for moving the respective parking robot from the start position to the target position, optionally also over a plurality of levels of a covered car park. The parking robot thus possesses the necessary components to enable an autonomous transportation of at least a sub-mass of the transportation vehicle.

In at least one further disclosed design embodiment, it is provided that the parking robot comprises a communications interface for a communications link to at least one further parking robot. By way of the communications link which is implemented, for example, as a wireless radio connection such as, for example, a WLAN connection, the parking robot can receive, for example, a travel trajectory from the covered car park administration server or a pilot robot, but can also transmit respective data and signals, for example, items of information pertaining to the approaching ball in the region of the parking robot to other parking robots, the pilot robot, or the covered car park administration server. On account thereof, an interaction between a plurality of parking robots, an interaction with a pilot robot in a parking robot system, and/or an exchange of data with an infrastructural administration server, for example, becomes possible in a beneficial manner.

A method for operating a parking robot as has been described above is moreover provided according to the disclosure. The disclosed design embodiments and the benefits thereof presented in the context of the disclosed parking robot apply in analogous manner, in as far as the disclosed design embodiments and benefits can be applied to the disclosed method for operating a parking robot of this type. The method for operating the parking robot comprises the following operations: autonomously moving the parking robot from the outside to a receiving position beside a wheel of a wheel axle of a transportation vehicle, wherein the respective wheel bearing arms of the parking robot are in each case disposed so as to be parallel with the wheel axle, and one of the wheel bearing arms in a transportation vehicle longitudinal direction is positioned in front of the wheel and the other wheel bearing arm in the wheel longitudinal direction is positioned behind the wheel, and raising the wheel of the transportation vehicle by correspondingly rotating the respective wheel bearing arm about the respective rotation axis in a predefined rotation direction, wherein the respective rotation directions of the respective wheel bearing arms are in each case mutually opposed.

In at least one exemplary design embodiment of the disclosed method, it is provided that three further parking robots have in each case raised one further wheel of a total of four wheels of the transportation vehicle. It is moreover provided that the four parking robots move in each case so as to correspond to respective provided travel trajectories to a predefined target position, and at the latter set down the transportation vehicle by correspondingly rotating the respective wheel bearing arms in the respective opposite rotation direction. A transportation vehicle having four wheels, by a parking robot system which comprises four parking robots, for example, by the described method can thus be moved from a drop-off position in an entry region of the covered car park, for example, to a parking bay, for example, in an upper level of the covered car park, and there be set down on the parking bay. Alternatively thereto, as many parking robots as the transportation vehicle has wheels on which the latter travels can at all times be provided for a transportation vehicle.

Items of information pertaining to the travel route as well as to the desired target position can be provided by a covered car park administration server, that is to say by an infrastructural administration server. Alternatively or additionally thereto, the four parking robots while transporting the transportation vehicle through the covered car park can be accompanied by a pilot robot which, for example, autonomously travels ahead of the transportation vehicle which is supported by the four parking robots, and herein provides respective control signals such as, for example, respective travel trajectories for the respective parking robots which presently represent one parking robot system, on account of which particularly rapid, ramp-capable travel of the transportation vehicle through the covered car park becomes possible by the plurality of parking robots, wherein the plurality of parking robots are herein configured so as to be scaled particularly small and cost-effective in terms of the implementation of the lifting mechanism of the wheel of the transportation vehicle. On account thereof it is possible for the transportation vehicle to be set down particularly close beside other transportation vehicles, on account of which particularly tight and space-saving parking is enabled within the covered car park.

The control installation for the transportation vehicle is also part of the disclosed embodiments. The control installation has a processor installation which is specified for carrying out an exemplary embodiment of the disclosed method. To this end, the processor installation can have at least one microprocessor and/or at least one microcontroller. The processor installation can furthermore have a program code which when executed by the processor installation is specified for carrying out the exemplary embodiment of the disclosed method. The program code can be stored in a data memory of the processor installation.

In the case of the exemplary embodiment, the components of the embodiment described represent in each case individual features of the disclosure which are to be considered independently and which refine the disclosure in each case also in a mutually independent manner and are therefore also to be considered individually or in any combination other than the combination shown to be a component part of the disclosure. Furthermore, the embodiment described can also be enhanced by further features already described.

Functionally equivalent elements in the figures are in each case provided with the same reference signs.

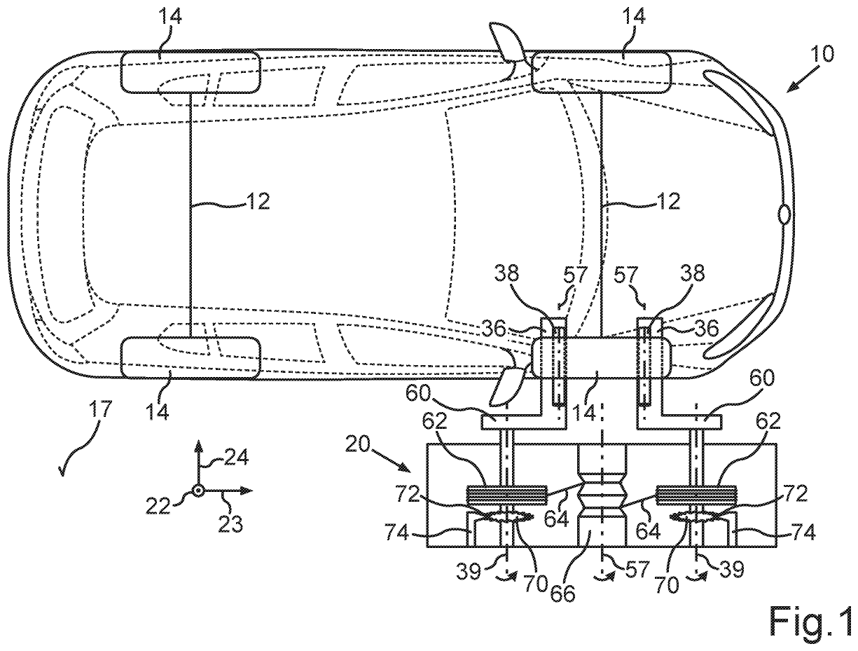

A transportation vehicle 10 which has two wheel axles 12 having in each case two wheels 14 is schematically illustrated in FIG. 1. The front right wheel 14 of the transportation vehicle 10 herein has been raised with the aid of a parking robot 20. A plan view of the parking robot 20 as well as the transportation vehicle 10 is illustrated in FIG. 1.

The parking robot 20 has a pair of wheel bearing arms 36 which have in each case one slip roller 38, the rotation axis 57 of the slip roller 38 being disposed so as to be parallel with a shaft element that is rotatable about a respective rotation axis 39, the respective wheel bearing arm 36 by a respective crank element 60 being at least indirectly mounted so as to be rotatable about the rotation axis 39.

The respective wheel bearing arm 36 of the parking robot 20 by way of the respective crank element 60 is moreover at least indirectly coupled rigidly to a respective eccentric cable drum 62. One cable 64 which is produced from steel, for example, is in each case wound around the respective eccentric cable drum 62, and the respective cable drum 62 is mounted so as to be rotatable about the rotation axis 39. Moreover, a lock disk 70 is in each case mounted so as to be rotatable about the respective rotation axis 39, the lock disk 70 being coupled to the respective crank element 60. The respective lock disk 70 is moreover assigned a safety key 72 which by a respective holding element 74 can be brought to bear on the respective lock disk 70 or be removed from the latter.

The parking robot 20 moreover has a central drive unit 66 which is rotatable about the rotation axis 57 and is conceived for winding or unwinding the respective cable 64 on the respective eccentric cable drum 62.

The parking robot 20 is conceived for autonomously moving from the outside to a receiving position beside the wheel 14 of the wheel axle 12 of the transportation vehicle 10. The parking robot 20 in FIG. 1 is situated in the receiving position in which the respective wheel bearing arms 36 are in each case disposed so as to be parallel with the wheel axle 12, and one of the wheel bearing arms 36 in a transportation vehicle longitudinal direction which corresponds to a parking robot longitudinal direction 23 is positioned in front of the wheel 14, and the other wheel bearing arm 36 in the transportation vehicle longitudinal direction is disposed behind the wheel 14. The respective rotation axes 57 of the respective slip rollers 38, the respective rotation axes 39, as well as the rotation axis 57 of the central drive unit 66 are thus all disposed so as to be parallel with a parking robot transverse direction 24. The parking robot vertical direction 22 is aligned so as to be perpendicular to the parking robot longitudinal direction 23 and to the parking robot transverse direction 24.

The parking robot 20 by correspondingly rotating the respective wheel bearing arm 36 about the respective rotation axis 39 in a predefined respective rotation direction is now conceived for raising the wheel 14 of the transportation vehicle 10. The respective rotation directions of the respective wheel bearing arms 36 herein are mutually opposed. For example, the one wheel bearing arm 36 is rotated about the rotation axis 39 in the clockwise direction, whereas the other wheel bearing arm 36 is rotated about the rotation axis 39 in the counter clockwise direction, for example.

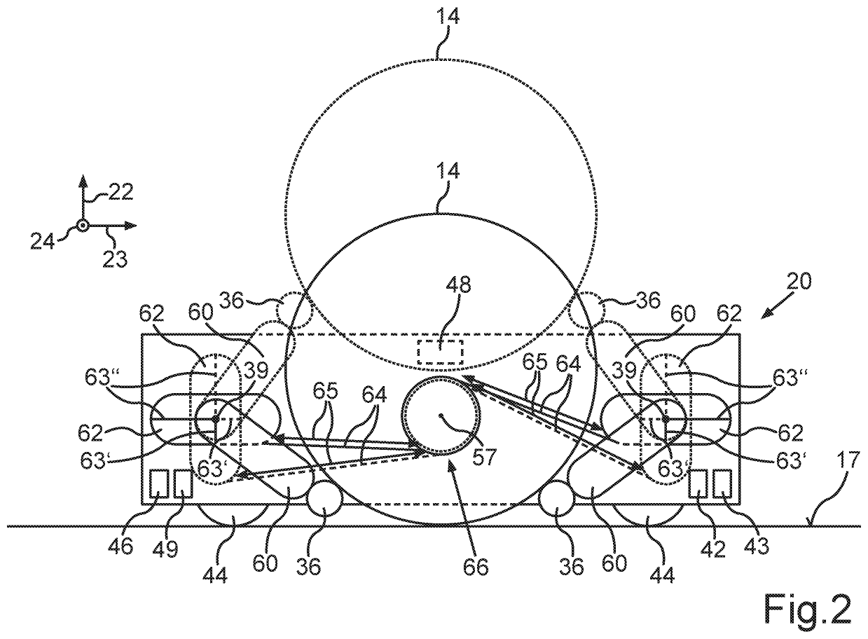

Two different positions of the respective wheel bearing arms 36 are schematically illustrated in a longitudinal section of the parking robot 20 in FIG. 2. A first position of the respective wheel bearing arms 36 as well as of a wheel 14 of the transportation vehicle 10 herein is identified by solid lines, whereas the second position is in each case schematically illustrated by dashed lines.

Reference is now first made to the first position of the respective wheel bearing arms 36 of the parking robot 20, schematically illustrated by solid lines. This position schematically illustrates a respective arrangement of the respective wheel bearing arms 36 when commencing the raising of the wheel 14 from a driving floor 17 on which the parking robot 20 as well as the transportation vehicle 10 stand. The parking robot 20 herein stands on the driving floor 17 by way of two drive wheels 44. The respective eccentric cable drum 62 are schematically illustrated in addition to the respective wheel bearing arms as well as the respective crank element 60 in FIG. 2. The respective eccentric cable drum 62 is shaped so as to be elliptic and therefore has two different drum radii 63′ and 63″. Therefore, the respective eccentric cable drum 62 in a first sub-region has a first predefined drum radius 63′, for example, and in a second sub-region has a second predefined drum radius 63″, wherein the second drum radius 63″ is larger than the first drum radius 63′. Prior to actually raising the wheel 14 of the transportation vehicle 10, the eccentric cable drum 62 is now oriented in such a manner that the shorter, first, drum radius 63′ is disposed so as to be parallel with the parking robot vertical direction 22, and the cable 64 between the eccentric cable drum 62 and a corresponding winding drum of the central drive unit 66 thus has a short cable length 65.

For the wheel 14 of the transportation vehicle 10 to now be moved upward in the parking robot vertical direction 22 and thus to raise the wheel 14 farther away from the driving floor 17, the eccentric cable drum 62 is rotated by a total of 90 degrees and thereupon assumes a position in which the larger, second, drum radius 63″ is disposed so as to be parallel with the parking robot vertical direction 22, as is schematically illustrated by the dashed lines. On account thereof, the cable length 65 of the cable 64 is increased in comparison to the first described position of the eccentric cable drum 62. On account thereof, a lever arm by way of which a force is applied for raising the wheel 14 is significantly increased between the first and the second position since the corresponding cable length 65 is increased, and the lever arm length is thus increased. An increasingly greater force for raising the wheel 14 is thus provided by the central drive unit 66 while raising the wheel 14 of the transportation vehicle 10.

Various further components of the parking robot 20 are moreover schematically illustrated in FIG. 2. The parking robot 20 has a sensor installation 48, on the one hand, the sensor installation 48 being, for example, a camera or a radar apparatus which is conceived for detecting an environment of the parking robot 20 as well as for localizing obstacles to the parking robot 20 in the detected environment. The parking robot 20 moreover has an electric drive machine 42, a battery 43 for supplying the electric drive machine 42 with electric power, and the two drive wheels 44. The parking robot 20 by the electric drive machine 42 is thus conceived for driving the two drive wheels 44 for moving the parking robot 20. Corresponding actuation commands herein can be provided by the control installation 49. The control installation 49 can moreover be conceived for determining a travel trajectory for the parking robot 20, for example, within a predefined infrastructural environment such as, for example, a covered car park, based on the data provided and detected by the sensor installation 48 pertaining to the environment of the parking robot 20 as well as the obstacles localized in the detected environment. The parking robot 20 moreover has a communications interface 46, specifically for a communications link to the at least one further parking robot 20. Alternatively thereto, a communications link to an infrastructural administration server such as, for example, a covered car park administration server, or to a pilot robot, can also be established by way of the communications interface 46, the travel trajectory of the parking robot 20 being able to be transmitted or received by way of the communications link.

The parking robot 20 can now be operated in such a manner, for example, that the parking robot 20 firstly autonomously moves from the outside to the receiving position beside the wheel 14 of the transportation vehicle 10 and there, by correspondingly rotating the respective wheel bearing arm 36 about the respective rotation axis 39 in a respective predefined rotation direction, raises the wheel 14. When a procedure of this type is additionally performed by three further parking robots 20 at the three further wheels 14 of the total of four wheels 14 of the transportation vehicle 10, for example, the transportation vehicle 10 by the total of four parking robots 20 can be completely raised from the driving floor 17. The four respective parking robots 20 thereupon, in a manner corresponding to respective provided travel trajectories, can travel to a predefined target position, for example, a parking bay, within a covered car park, and by correspondingly rotating the respective wheel bearing arms 36 in the respective opposite rotation direction there set down the transportation vehicle 10 again. The parking robots 20 thereupon can autonomously travel to a further transportation vehicle, for example, for the transportation vehicle to also be autonomously parked at a corresponding target position, for example.

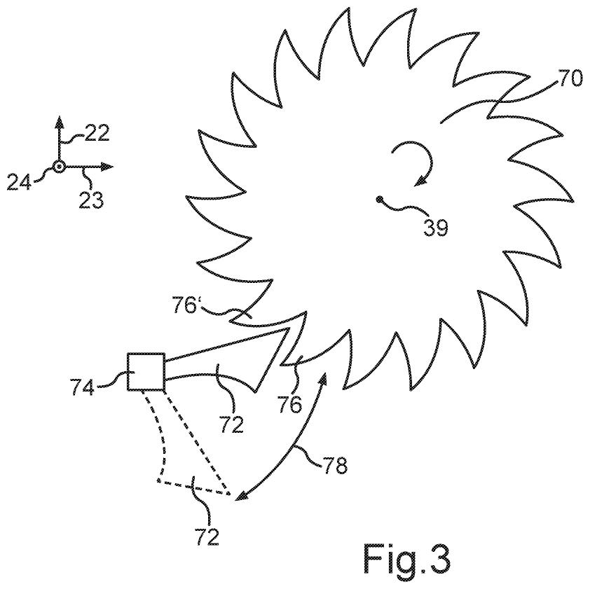

A safety mechanism for the parking robot 20 is schematically illustrated in FIG. 3. The safety mechanism comprises the lock disk 70 which, coupled to the respective crank element 60 and the respective wheel bearing arm 36, is mounted so as to be rotatable about the respective rotation axis 39. The respective lock disk 70 herein is disposed so as to be parallel with the respective cable drum 62, that is to say in the plane which is defined by the parking robot vertical direction 22 and the parking robot longitudinal direction 23. A surface of the lock disk 70 is thus disposed so as to be perpendicular to the rotation axis 39. The holding element 74 for the safety key 72 of the lock disk 70 is disposed so as to be lateral to the lock disk 70. A position of the safety key 72 in which the safety key 72 by the holding element 74 is brought to bear on the lock disk 70 herein is schematically illustrated by the solid lines. The safety key 72 is always situated in this position when the wheel 14 of the transportation vehicle 10 is to be raised by the wheel bearing arms 36 and/or when the wheel 14 is to be held in the raised position. In a rotation of the respective lock disk 70 about the rotation axis 39 in the predefined rotation direction, which presently is schematically illustrated by a small arrow, the safety key 72 moves from one tooth 76 to an adjacent tooth 76′ of the lock disk 70. However, a rotation about the rotation axis 39 in the opposite rotation direction is blocked by virtue of the schematically illustrated shape of the respective teeth 76, 76″. To this end, the respective teeth 76, 76′ have two dissimilar sides, a flat side and a side which in comparison thereto is steeper.

The safety key 72 for setting down the wheel 14 of the transportation vehicle 10, during a respective rotation of the respective wheel bearing arm 36 about the respective rotation axis 39 in the opposite rotation direction, is conceived to be held at a predefined spacing 78 from the lock disk 70 by the holding element 74. This position of the safety key 72 is likewise schematically illustrated by dashed lines in FIG. 3. In this position of the safety key 72, the safety key 72 does not contact the respective teeth 76, 76′ of the lock disk 70 and can thus also not block the rotating movement in the opposite rotation direction. This position of the safety key 72 is chosen, for example, when setting down the wheel 14.

The example overall shows how a lifting mechanism having a central drive unit 66 can be implemented by way of the parking robot 20. A precondition therefor is the eccentric cable drum 62 such as designed so as to be elliptic, for example. Alternatively to the elliptic design of the respective cable drum 62 illustrated in a schematic manner, the cable drum 62 can also have more complex shapes on account of which a plurality of respective drum radii 63′, 63″ are possible, for example, and a more differentiated force profile is enabled during one rotation about the respective rotation axis 39.

### LIST OF REFERENCE SIGNS

10 Transportation vehicle
12 Wheel axle
14 Wheel
17 Driving floor
20 Parking robot
22 Parking robot vertical direction
23 Parking robot longitudinal direction
24 Parking robot transverse direction
36 Wheel bearing arm
38 Slip roller
39 Rotation axis
42 Drive machine
43 Battery
44 Drive wheel
46 Communications interface
48 Sensor installation
49 Control installation
57 Rotation axis
60 Crank element
62 Cable drum
63′, 63″ Drum radius
64 Cable
65 Cable length
66 Central drive unit
70 Lock disk
72 Safety key
74 Holding element
76, 76′ Tooth
78 Spacing

1. A parking robot for a transportation vehicle, the parking robot comprising:
a pair of wheel bearing arms which, by use of a crank element, are in each case at least indirectly mounted to be rotatable about a respective rotation axis,
wherein the parking robot autonomously moves from the outside to a receiving position beside a wheel of a wheel axle of the transportation vehicle in which the respective wheel bearing arms are disposed parallel with the wheel axle and one of the wheel bearing arms in a vehicle longitudinal direction is positioned in front of the wheel and the other wheel bearing arm in the vehicle longitudinal direction is positioned behind the wheel,
wherein the parking robot raises the wheel of the transportation vehicle by correspondingly rotating the respective wheel bearing arm about the respective rotation axis in a predefined rotation direction, and
wherein the respective rotation directions of the respective wheel bearing arms are mutually opposed.

2. The parking robot of claim 1, further comprising an eccentric cable drum and a central drive unit, wherein the respective wheel bearing arm, by way of the respective eccentric cable drum, is at least indirectly coupled rigidly to the respective crank element, the cable drum having a first sub-region having a predefined first drum radius and a second sub-region having a predefined second drum radius which is larger than the first drum radius, wherein a respective cable is wound around the cable drum and the cable drum is mounted to be rotatable about the rotation axis, and the central drive unit winds and unwinds the respective cable in an alternating state on the respective cable drum.

3. The parking robot of claim 1, further comprising a respective lock disk coupled to the respective crank element and mounted to be rotatable about the respective rotation axis, wherein the respective lock disk is assigned a safety key which, when bearing on the lock disk by a holding element, in the rotation of the respective lock disk moves about the respective rotation axis in the predefined rotation direction from one tooth of the lock disk to another tooth adjacent in the rotation direction, and blocks a rotation in the opposite rotation direction.

4. The parking robot of claim 3, wherein the safety key for setting down the wheel of the transportation vehicle during a corresponding rotation of the respective wheel bearing arm about the respective rotation axis in the opposite rotation direction is implemented by the holding element for holding at a predefined spacing from the lock disk.

5. The parking robot of claim 1, wherein the respective wheel bearing arms have a respective slip roller, the respective rotation axis of the slip roller is parallel with the rotation axis.

6. The parking robot of claim 1, further comprising a sensor installation for detecting an environment of the parking robot and for localizing obstacles to the parking robot in the detected environment.

7. The parking robot of claim 1, further comprising an electric drive machine, a battery for supplying the electric drive machine with electric power, and at least one drive wheel, and wherein the electric drive machine drives the at least one drive wheel for moving the parking robot.

8. The parking robot of claim 1, further comprising a communications interface for a communications link to at least one further parking robot.

9. A method for operating a parking robot having a pair of wheel bearing arms which, by using a crank element, are at least indirectly mounted rotatably about a respective rotation axis, the method comprising:
autonomously moving the parking robot from the outside to a receiving position beside a wheel of a wheel axle of a transportation vehicle, wherein the respective wheel bearing arms of the parking robot are parallel with the wheel axle and one of the wheel bearing arms in a vehicle longitudinal direction is positioned in front of the wheel and the other wheel bearing arm in the vehicle longitudinal direction is positioned behind the wheel; and
raising the wheel of the transportation vehicle by correspondingly rotating the respective wheel bearing arm in a predefined respective opposite rotation direction about the respective rotation axis.

10. The method of claim 9, wherein three further parking robots each raise one further wheel for a total of four wheels of the transportation vehicle, the four parking robots move to respectively provided travel trajectories to a predefined target position, and at the predefined target position set down the transportation vehicle by correspondingly rotating the respective wheel bearing arms in the respective opposite rotation direction.

11. The method of claim 9, wherein the respective wheel bearing arm, by way of the respective eccentric cable drum, is at least indirectly coupled rigidly to the respective crank element, the cable drum having a first sub-region having a predefined first drum radius and a second sub-region having a predefined second drum radius which is larger than the first drum radius, wherein a respective cable is wound around the cable drum and the cable drum is mounted to be rotatable about the rotation axis, and a central drive unit of the parking robot winds and unwinds the respective cable in an alternating state on the respective cable drum.

12. The method of claim 9, wherein a respective lock disk coupled to the respective crank element and mounted to be rotatable about the respective rotation axis is assigned a safety key which, when bearing on the lock disk by a holding element, in the rotation of the respective lock disk moves about the respective rotation axis in the predefined rotation direction from one tooth of the lock disk to another tooth adjacent in the rotation direction, and blocks a rotation in the opposite rotation direction.

13. The method of claim 9, further comprising setting down the wheel of the transportation vehicle using the safety key during a corresponding rotation of the respective wheel bearing arm about the respective rotation axis in the opposite rotation direction, by the holding element holding at a predefined spacing from the lock disk.

14. The method of claim 9, wherein the respective wheel bearing arms have a respective slip roller, wherein the respective rotation axis of the slip roller is parallel with the rotation axis.

15. The method of claim 9, further comprising detecting an environment of the parking robot and localizing obstacles to the parking robot in the detected environment using a sensor installation.

16. The method of claim 9, further comprising driving the at least one drive wheel for moving the parking robot using an electric drive machine, and supplying electric power to the electric drive machine using a battery.

17. The method of claim 9, further comprising linking the parking robot to at least one further parking robot using a communications interface that establishes a communications link.
